(19) United States
(12) Patent Application Publication
(10) Pub. No.: US 2025/0208442 A1
(43) Pub. Date: Jun. 26, 2025

(54) APPARATUS, SYSTEM, AND METHOD FOR WIRELESSLY POWERING ELECTRICAL COMPONENTS ON OPTICAL ELEMENTS OF EYEWEAR FRAMES

(71) Applicant: Meta Platforms Technologies, LLC, Menlo Park, CA (US)

(72) Inventors: Yasuo Morimoto, Cupertino, CA (US); Jiang Zhu, Cupertino, CA (US); Kuan Pei Yap, San Jose, CA (US)

(21) Appl. No.: 18/391,025

(22) Filed: Dec. 20, 2023

(51) Int. Cl. G02C 11/00; G02B 27/00; G02B 27/01; G02C 13/00; H02J 50/00; H02J 50/20

(52) U.S. Cl. CPC G02C 11/10; G02B 27/017; G02C 13/001; H02J 50/005; H02J 50/20; G02B 27/0093; G02B 2027/0178

(57) ABSTRACT

An apparatus for wirelessly powering electrical components on optical elements of eyewear frames may include (1) an eyewear frame that supports at least one optical element, (2) at least one wireless power receiver disposed on the at least one optical element and configured to receive a wireless power transfer from a wireless power transmitter, and (3) at least one electrical component disposed on the at least one optical element and electrically coupled to the wireless power receiver, wherein the electrical component is powered by the wireless power transfer. Various other apparatuses, systems, and methods are also disclosed.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 illustrates an exemplary apparatus for wirelessly powering electrical components on optical elements of eyewear frames in accordance with one or more implementations.

FIG. 2 illustrates an exemplary apparatus for wirelessly powering electrical components on optical elements of eyewear frames in accordance with one or more implementations.

FIG. 3 illustrates an exemplary implementation of an eyewear frame that facilitates wirelessly powering electrical components on optical elements in accordance with one or more embodiments.

FIG. 4 illustrates an exemplary apparatus for wirelessly powering electrical components on optical elements of eyewear frames in accordance with one or more implementations.

FIG. 5 illustrates an exemplary system for wirelessly powering electrical components on optical elements of eyewear frames in accordance with one or more implementations.

FIG. 6 illustrates an exemplary system for wirelessly powering electrical components on optical elements of eyewear frames in accordance with one or more implementations.

FIG. 7 illustrates an exemplary method for wirelessly powering electrical components on optical elements of eyewear frames in accordance with one or more implementations.

FIG. 8 is an illustration of exemplary augmented-reality glasses that may be used in connection with one or more implementations of this disclosure.

FIG. 9 is an illustration of an exemplary virtual-reality headset that may be used in connection with one or more implementations of this disclosure.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION OF EXEMPLARY IMPLEMENTATIONS

Current eye-tracking techniques are often incorporated into different types of head-mounted displays (HMDs). For example, these techniques typically include physical components that observe a viewer's eye movement to determine what the viewer is looking at within a display. In some implementations, these components may include one or more lights that shine onto the viewer's eyes and one or more cameras that observe how the one or more lights are reflected by the viewer's eyes.

As HMDs become smaller and more sophisticated, the physical components of typical eye-tracking systems can be problematic. For example, a pair of augmented-reality (AR) glasses may include and/or represent an eye-tracking system. In this example, the eye-tracking system may include and/or represent multiple light-emitting diodes (LEDs) that are positioned on lenses and configured to shine light onto a user's eyes. Additionally or alternatively, the eye-tracking system may include and/or represent one or more cameras that detect reflections and/or glints from the light. In certain implementations, the AR glasses may also include and/or represent circuitry that monitors, senses, and/or tracks the user's eyes based at least in part on the reflections and/or glints.

In some examples, to achieve successful eye-tracking functionality, the LEDs may be positioned in areas of the lenses that coincide with the user's line of sight and/or the user's periphery vision. As the LEDs need power to activate the shining of light, some AR glasses may include and/or represent traces disposed across the lenses between the frame of the AR glasses and the LEDs. In one example, these traces may carry electric power from a battery onboard the AR glasses to the LEDs. Unfortunately, such traces may be visible to the user when operating the AR glasses. As a result, these traces may distract and/or disturb the user, potentially impairing the user's experience with the AR glasses.

In an effort to remedy such distractions and/or disturbances, the apparatuses, systems, and methods disclosed herein may mitigate and/or eliminate the need for traces between the frame of the AR glasses and the LEDs. For example, rather than drawing power from a battery onboard a pair of AR glasses, the LEDs included in an eye-tracking system may be powered by wireless power transfers (e.g., near-field and/or far-field power transfers). In this example, the AR glasses may include wireless power receivers positioned adjacent and/or proximate to the LEDs on the lenses. The wireless power receivers may receive wireless power transfers from a wireless power transmitter. In one example, the wireless power transmitter may be coupled to and/or incorporated in the AR glasses.

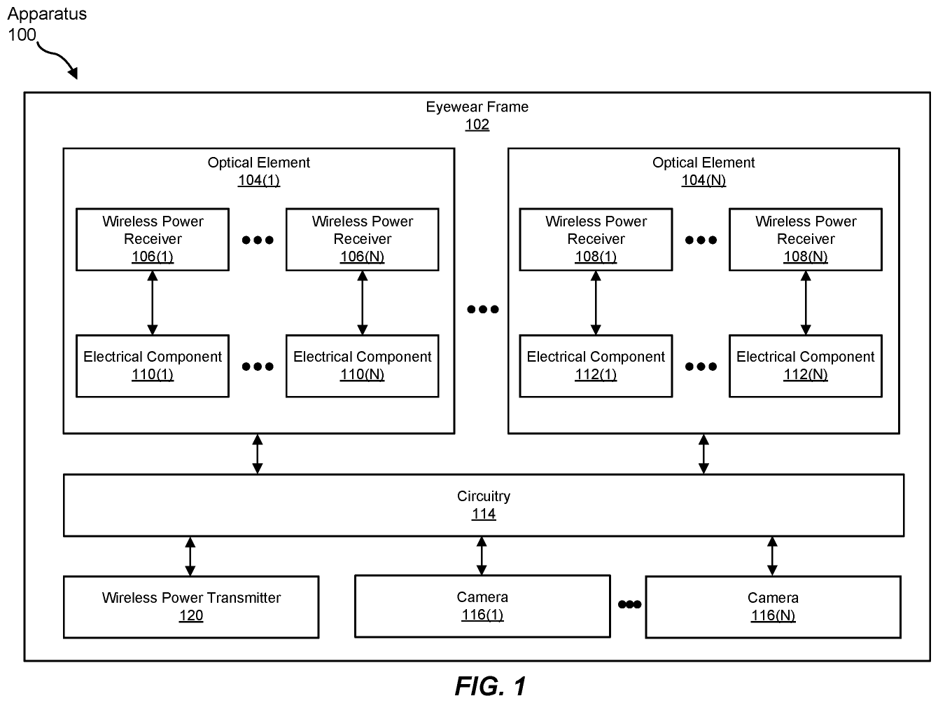

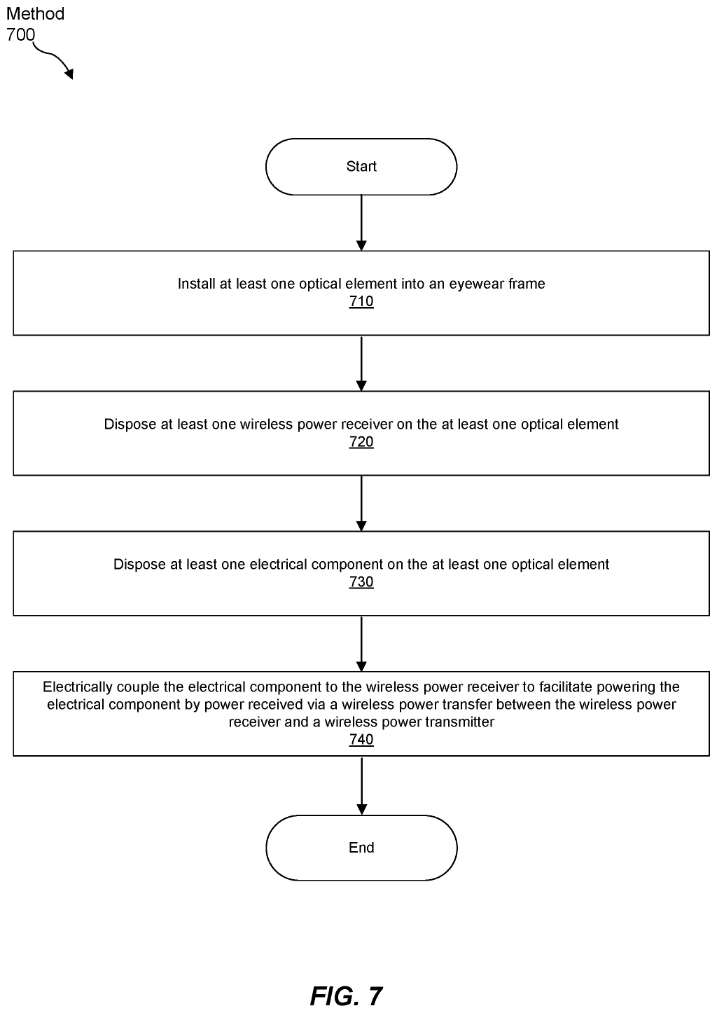

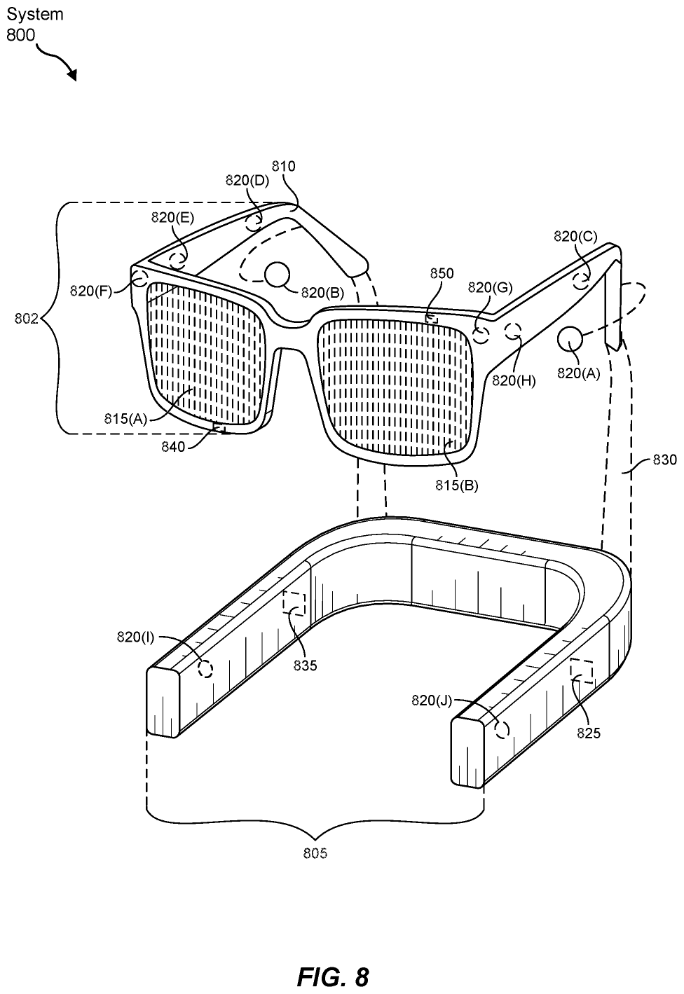

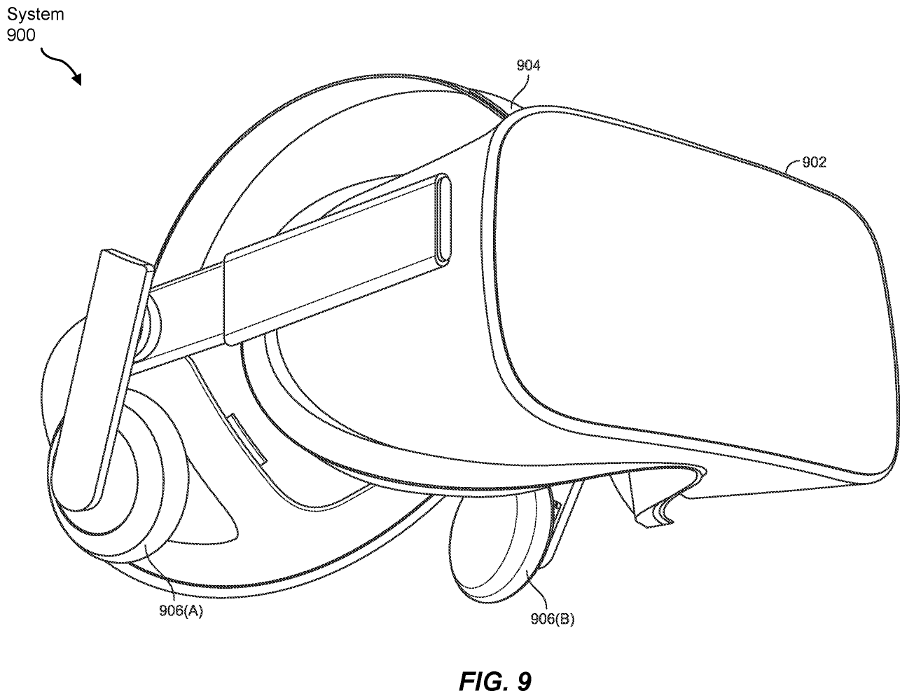

The following will provide, with reference to FIGS. 1-6, detailed descriptions of exemplary apparatuses, devices, systems, and corresponding configurations or implementations for wirelessly powering electrical components on optical elements of eyewear frames. In addition, detailed descriptions of methods for wirelessly powering electrical components on optical elements of eyewear frames will be provided in connection with FIG. 7. The discussion corresponding to FIGS. 8 and 9 will provide detailed descriptions of types of exemplary artificial-reality devices, wearables, and/or associated systems capable of wirelessly powering electrical components on optical elements of eyewear frames.

FIG. 1 illustrates an exemplary apparatus 100 for wirelessly powering electrical components on optical elements of eyewear frames. As illustrated in FIG. 1, apparatus 100 may include and/or represent an eyewear frame 102 dimensioned to be worn by a user. In some examples, eyewear frame 102 may include, support, and/or be equipped with one or more optical elements 104(1)-(N), circuitry 114, one or more cameras 116(1)-(N), and/or a wireless power transmitter 120. In one example, optical element 104(1) may include and/or represent one or more wireless power receivers 106(1)-(N) configured to receive wireless power transfers from wireless power transmitter 120. In this example, wireless power receivers 106(1)-(N) may be electrically and/or communicatively coupled to one or more electrical components 110(1)-(N) that are powered by the wireless power transfers.

In some examples, optical element 104(N) may include and/or represent one or more wireless power receivers 108(1)-(N) configured to receive wireless power transfers from wireless power transmitter 120. Additionally or alternatively, wireless power receivers 108(1)-(N) may be electrically and/or communicatively coupled to one or more electrical components 112(1)-(N).

In some examples, wireless power receivers 106(1)-(N) and/or electrical components 110(1)-(N) may be disposed on and/or secured to optical element 104(1). Additionally or alternatively, wireless power receivers 108(1)-(N) and/or electrical components 112(1)-(N) may be disposed on and/or secured to optical element 104(N).

In some examples, optical elements 104(1)-(N) may be inserted and/or installed in eyewear frame 102. In other words, optical elements 104(1)-(N) may be coupled to, incorporated in, and/or held by eyewear frame 102. In one example, optical elements 104(1)-(N) may be configured and/or arranged to provide one or more virtual features for presentation to a user wearing apparatus 100. These virtual features may be driven, influenced, and/or controlled by circuitry 114 and/or one or more wireless technologies supported by apparatus 100.

In some examples, optical elements 104(1)-(N) may each include and/or represent optical stacks, lenses, and/or films. In one example, optical elements 104(1)-(N) may each include and/or represent various layers that facilitate and/or support the presentation of virtual features and/or elements that overlay real-world features and/or elements. Additionally or alternatively, optical elements 104(1)-(N) may each include and/or represent one or more screens, lenses, and/or fully or partially see-through components. Examples of optical elements 104(1)-(N) include, without limitation, electrochromic layers, dimming stacks, transparent conductive layers (such as indium tin oxide films), metal meshes, antennas, transparent resin layers, lenses, films, combinations or variations of one or more of the same, and/or any other suitable optical elements.

In some examples, wireless power receivers 106(1)-(N) and/or 108(1)-(N) may each include and/or represent one or more antennas and/or rectifiers. In one example, the antennas may receive and/or obtain wireless power transfers from a wireless power transmitter incorporated in eyewear frame 102. Such wireless power transfers may introduce, provide, and/or pass alternating current (AC) power to the antennas. In this example, the antennas may convey, provide, and/or deliver AC power to the rectifiers, which convert the AC power into DC power. The rectifiers may then convey, provide, and/or deliver the DC power to electrical components 110(1)-(N) and/or 112(1)-(N). In certain implementations, wireless power receivers 106(1)-(N) and/or 108(1)-(N) may be completely and/or substantially invisible and/or transparent from the user's perspective and/or view.

In some examples, wireless power receivers 106(1)-(N) and/or 108(1)-(N) may each include and/or represent any type or form of device, component, and/or mechanism capable of wirelessly receiving and/or obtaining power or generating electric current in response to stimuli received wirelessly. For example, wireless power receivers 106(1)-(N) and/or 108(1)-(N) may include and/or represent one or more induction coils that generate, create, and/or produce an electric current through electromagnetic induction initiated by a wireless power transmitter 120. In one example, wireless power transmitter 120 may be coupled to, embedded in, and/or incorporated in eyewear frame 102. In another example, although not necessarily illustrated in this way in FIG. 1, wireless power transmitter 120 may constitute and/or represent a separate and/or standalone device located in the environment where the user dons and/or operates eyewear frame 102.

In one example, wireless power transmitter 120 may transfer power and/or energy to wireless power receivers 106(1)-(N) and/or 108(1)-(N) via an inductive coupling. Accordingly, wireless power transmitter 120 may produce AC that traverses and/or passes through one or more induction coils, which generates a magnetic field whose strength vacillates relative to and/or commensurate with the AC. This magnetic field may then stimulate and/or induce an AC in the induction coils of wireless power receivers 106(1)-(N) and/or 108(1)-(N), which are subsequently used to power electrical components 110(1)-(N) and/or 112(1)-(N).

In another example, wireless power receivers 106(1)-(N) and/or 108(1)-(N) may include and/or represent one or more antennas that generate electric current through electromagnetic waves incident on wireless power receivers 106(1)-(N) and/or 108(1)-(N) from wireless power transmitter 120. In this example, wireless power transmitter 120 may transfer power and/or energy to wireless power receivers 106(1)-(N) and/or 108(1)-(N) via electromagnetic radiation. Accordingly, wireless power transmitter 120 may produce electromagnetic waves that radiate from wireless power transmitter 120 to wireless power receivers 106(1)-(N) and/or 108(1)-(N). These electromagnetic waves may then stimulate and/or induce an electric current in the antennas of wireless power receivers 106(1)-(N) and/or 108(1)-(N), which are subsequently used to power electrical components 110(1)-(N) and/or 112(1)-(N).

In some examples, wireless power receivers 106(1)-(N) and/or 108(1)-(N) may each include and/or represent a far-field receiver that is electromagnetically coupled, energized, and/or stimulated by wireless power transmitter 120. In other examples, wireless power receivers 106(1)-(N) and/or 108(1)-(N) may each include and/or represent a near-field receiver that is inductively coupled, energized, and/or stimulated by wireless power transmitter 120.

In some examples, wireless power transmitter 120 may include and/or represent a far-field transmitter. In other examples, wireless power transmitter 120 may include and/or represent a near-field transmitter.

In some examples, electrical components 110(1)-(N) and/or 112(1)-(N) may each include and/or represent any type or form of component, device, and/or feature that consumes electric power. In one example, electrical components 110(1)-(N) and/or 112(1)-(N) may each include and/or represent one or more LEDs and/or microLEDs. Additionally or alternatively, electrical components 110(1)-(N) and/or 112(1)-(N) may be positioned within or throughout optical elements 104(1)-(N) and/or be electrically isolated from other electrical components embedded in eyewear frame 102.

In some examples, circuitry 114 may include and/or represent one or more electrical and/or electronic circuits capable of processing, applying, modifying, transforming, displaying, transmitting, receiving, and/or executing data for apparatus 100. In one example, circuitry 114 may be electrically and/or communicatively coupled to optical elements 104(1)-(N) and/or cameras 116(1)-(N). In this example, cameras 116(1)-(N) may each be integrated into and/or secured to eyewear frame 102 and/or optical elements 104(1)-(N). In certain implementations, cameras 116(1)-(N) may be configured and/or programmed to detect at least portions of light emitted by LEDs and/or reflected by the user's eyes (e.g., in the form of glints).

In some examples, circuitry 114 may be configured to track movement of the user's eyes based at least in part on the portions of light detected by cameras 116(1)-(N). Additionally or alternatively, circuitry 114 may be configured to generate, modify, and/or change virtual content presented via optical elements 104(1)-(N) based at least in part on the movement of the user's eyes.

In some examples, circuitry 114 may launch, perform, and/or execute certain executable files, code snippets, and/or computer-readable instructions to facilitate and/or support wirelessly powering electrical components on optical elements of eyewear frames. Although illustrated as a single unit in FIG. 1, circuitry 114 may include and/or represent a collection of multiple processing units and/or electrical or electronic components that work and/or operate in conjunction with one another. Examples of circuitry 114 include, without limitation, processing devices, microprocessors, microcontrollers, application-specific integrated circuits (ASICs), central processing units (CPUs), graphics processing units (GPUs), field-programmable gate arrays (FPGAs), systems on chips (SoCs), parallel accelerated processors, tensor cores, integrated circuits, chiplets, receivers, transmitters, transceivers, analog and/or digital circuitry, onboard logic, transistors, antennas, resistors, capacitors, diodes, inductors, switches, registers, flipflops, connections, traces, buses, semiconductor (e.g., silicon) devices, and/or structures, storage devices, circuit boards, sensors, substrates, portions of one or more of the same, variations or combinations of one or more of the same, and/or any other suitable circuitry.

In some examples, apparatus 100 may include and/or represent an HMD and/or an artificial-reality device or system. Artificial reality may provide a rich, immersive experience in which users are able to interact with virtual objects and/or environments in one way or another. In this context, artificial reality may constitute and/or represent a form of reality that has been altered by virtual objects for presentation to a user. Such artificial reality may include and/or represent virtual reality (VR), AR, mixed reality, hybrid reality, or some combination and/or variation of one or more of the same.

In one example, the term “head-mounted display” and/or the abbreviation “HMD” may refer to any type or form of display device or system that is worn on or about a user's face and displays virtual content, such as computer-generated objects and/or AR content, to the user. HMDs may present and/or display content in any suitable way, including via a display screen, a liquid crystal display (LCD), an LED display, a microLED display, a plasma display, a projector, a cathode ray tube, an optical mixer, combinations or variations of one or more of the same, and/or any other suitable HMDs. HMDs may present and/or display content in one or more media formats. For example, HMDs may display video, photos, computer-generated imagery (CGI), and/or variations or combinations of one or more of the same. Additionally or alternatively, HMDs may include and/or incorporate see-through lenses that enable the user to see the user's surroundings in addition to such computer-generated content.

HMDs may provide diverse and distinctive user experiences. Some HMDs may provide virtual reality experiences (i.e., they may display computer-generated or pre-recorded content), while other HMDs may provide real-world experiences (i.e., they may display live imagery from the physical world). HMDs may also provide any mixture of live and virtual content. For example, virtual content may be projected onto the physical world (e.g., via optical or video see-through lenses), which may result in AR and/or mixed reality experiences.

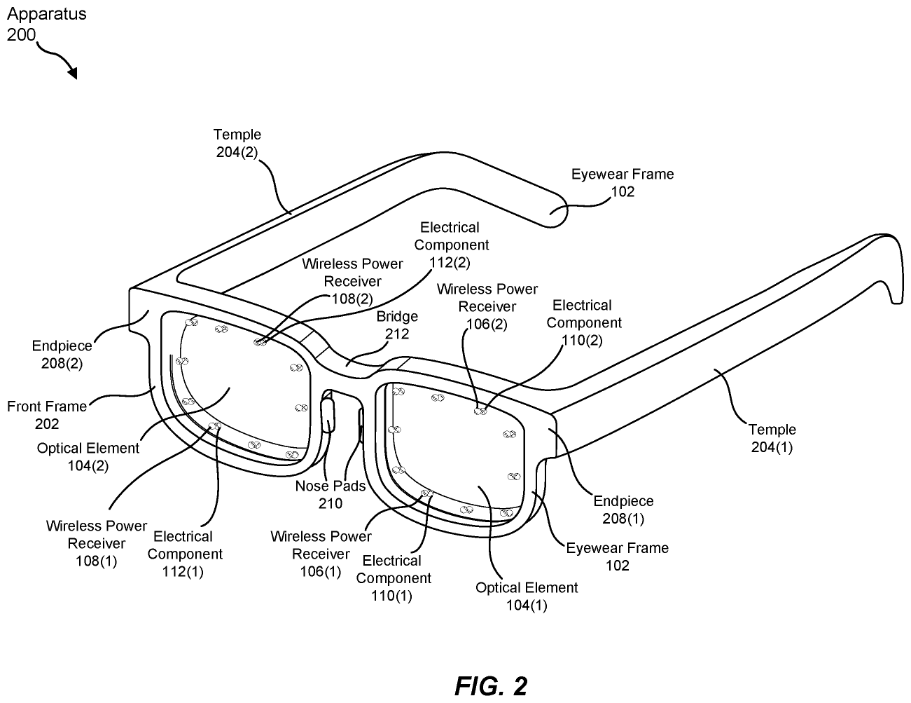

FIG. 2 illustrates an exemplary apparatus 200 for wirelessly powering electrical components on optical elements of eyewear frames. In some examples, apparatus 200 may include and/or represent certain devices, components, and/or features that perform and/or provide functionalities that are similar and/or identical to those described above in connection with FIG. 1. As illustrated in FIG. 2, apparatus 200 may include and/or represent eyewear frame 102 that facilitates, supports, and/or provides eye-tracking functionalities and/or artificial-reality experiences for a user. In one example, eyewear frame 102 may include and/or represent a front frame 202, temples 204(1) and 204(2), optical elements 104(1) and 104(2), endpieces 208(1) and 208(2), nose pads 210, and/or a bridge 212.

In some examples, wireless power receivers 106(1)-(N) and electrical components 110(1)-(N) may be disposed on, applied to, and/or secured to optical element 104(1). For example, wireless power receivers 106(1) and 106(2) may be positioned next and/or adjacent to electrical components 110(1) and 110(2), respectively, on optical element 104(1). Additionally or alternatively, wireless power receivers 108(1)-(N) and electrical components 112(1)-(N) may be disposed on, applied to, and/or secured to optical element 104(2). For example, wireless power receivers 108(1) and 108(2) may be positioned next and/or adjacent to electrical components 112(1) and 112(2), respectively, on optical element 104(2).

In some examples, wireless power receivers 106(1)-(N) and electrical components 110(1)-(N) may be placed, arranged, and/or positioned around or along the periphery and/or perimeter of optical element 104(1). Additionally or alternatively, wireless power receivers 108(1)-(N) and electrical components 112(1)-(N) may be placed, arranged, and/or positioned around or along the periphery and/or perimeter of optical element 104(2).

In some examples, one or more of electrical components 112(1)-(N) may be embedded, installed, and/or inserted in a hole and/or cavity included or formed in optical element 104(1) or 104(2). For example, holes and/or cavities may be created and/or formed by a laser in a transparent film. In this example, LEDs may be embedded, installed, and/or inserted in these holes and/or cavities. Additionally or alternatively, the LEDs may be secured, attached, and/or coupled to the transparent film via a transparent molding and/or adhesive that fully and/or partially envelops and/or surrounds the LEDs in the holes and/or cavities.

In some examples, conductive assemblies and/or electrical connections may be disposed, applied, and/or coupled between the LEDs and electrical traces (e.g., reduction traces). In one example, the conductive assemblies and/or electrical connections may carry power and/or current to and/or from electrical components 110(1)-(N) and/or other devices or features of apparatus 200. In certain implementations, the holes, cavities, molding, and/or adhesive may improve the flexibility of the transparent film and/or optical elements 104(1) and 104(2).

In some examples, one or more of electrical components 112(1)-(N) may be disposed, applied, and/or coupled proximate or next to a hole and/or cavity included or formed in optical element 104(1) or 104(2). For example, LEDs may be disposed, applied, and/or coupled proximate and/or next to holes and/or cavities created and/or formed in a transparent film. In this example, the holes and/or cavities may serve and/or function as vias through which electrical power and/or current passes and/or traverses.

In some examples, conductive assemblies and/or electrical connections may be disposed, applied, and/or coupled between the LEDs and electrical traces (e.g., reduction traces) via the holes and/or cavities formed in the transparent film. In one example, electrical traces that support the flow of current for the LEDs may be disposed, applied, and/or coupled on both sides of the transparent film. In this example, the conductive assemblies and/or electrical connections may pass and/or traverse through the holes and/or cavities to provide continuity between the electrical traces on both sides of the transparent film. In certain implementations, the conductive assemblies and/or electrical connections may carry power and/or current to and/or from the LEDs via the holes and/or cavities.

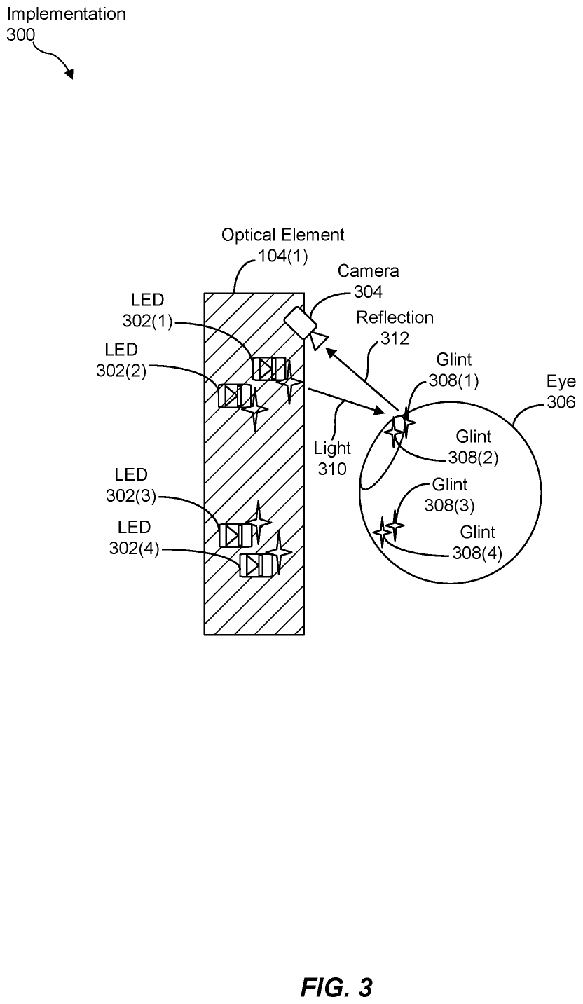

FIG. 3 illustrates an exemplary implementation 300 of apparatus 100 or 200 for wirelessly powering electrical components on optical elements of eyewear frames. In some examples, implementation 300 may include, involve, and/or represent certain devices, components, and/or features that perform and/or provide functionalities that are similar and/or identical to those described above in connection with either FIG. 1 or FIG. 2. As illustrated in FIG. 3, implementation 300 may include and/or represent eye-tracking features and/or functionalities facilitated, provided, and/or supported by LEDs 302(1), 302(2), 302(3), and/or 302(4) disposed on and/or embedded within optical element 104(1). In one example, one or more of LEDs 302(1)-(4) may emit, transmit, and/or shine light 310 on an eye 306 of a user.

In some examples, the eye-tracking features and/or functionalities may also be facilitated, provided, and/or supported by a camera 304 that detects a reflection 312 of light 310 from eye 306 of the user. In one example, camera 304 may identify and/or detects glints 308(1), 308(2), 308(3), and/or 308(4) in certain locations of eye 306 based at least in part on reflection 312. In certain implementations, circuitry 114 may be able to track and/or monitor movements of eye 306 based at least in part on glints 308(1)-(4). Accordingly, implementation 300 may involve and/or rely on camera 304 and/or circuitry 114 observing how eye 306 reflects light 310.

As a specific example, eye 306 may view virtual content displayed via optical element 104(1) installed in an AR HMD. In one example, implementation 300 may involve and/or represent an eye-tracking system that includes LEDS 302(1)-(4) positioned on one or more layers of optical element 104(1). In this example, LEDs 302(1)-(4) may shine light 310 onto eye 306. Due to the common physiology of the eye 306, the eye-tracking system may rely on glints 308(1)-(4) and/or corneal reflections to determine how the eye 306 is moving and/or rotating. For example, the eye-tracking system may rely on images of the glints 308(1)-(4) captured by camera 304 to identify and/or discern a position of the pupil of eye 306 relative to any/all of glints 308(1)-(4). From this information, the eye-tracking system may determine a position of the eye 306 relative to the virtual content displayed on one or more additional layers of optical element 104(1).

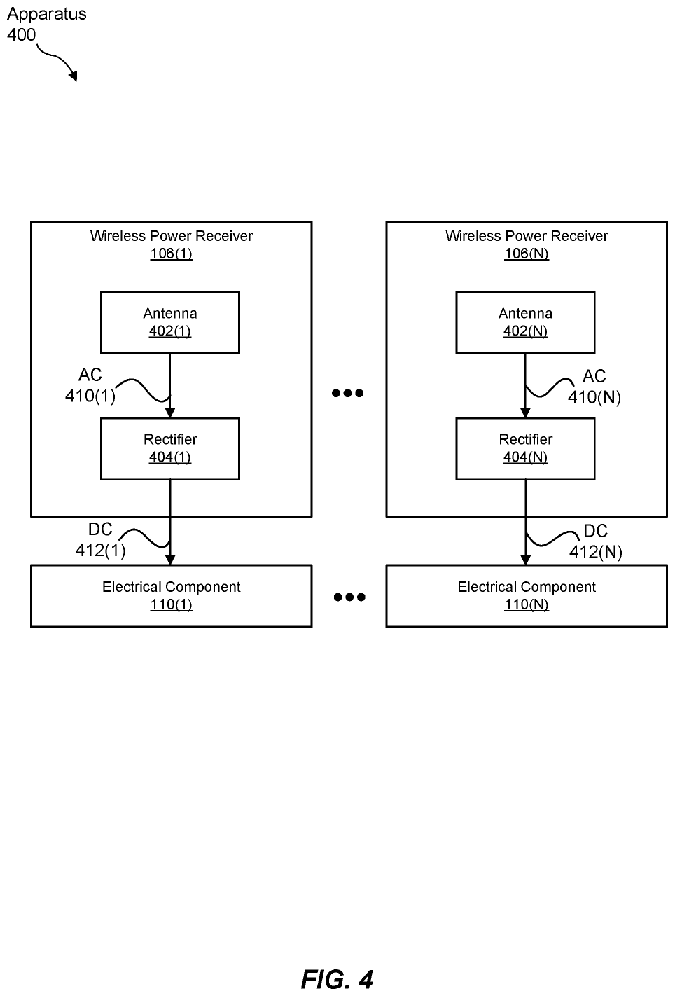

FIG. 4 illustrates an exemplary apparatus 400 for wirelessly powering electrical components on optical elements of eyewear frames. In some examples, apparatus 400 may include and/or represent certain devices, components, and/or features that perform and/or provide functionalities that are similar and/or identical to those described above in connection with any of FIGS. 1-3. As illustrated in FIG. 4, apparatus 400 may include and/or represent wireless power receivers 106(1)-(N) and electrical components 110(1)-(N) that are electrically and/or communicatively coupled to one another. In one example, wireless power receivers 106(1)-(N) may include and/or represent antennas 402(1)-(N) and rectifiers 404(1)-(N), respectively. In this example, antennas 402(1)-(N) may be electrically and/or communicatively coupled to rectifiers 404(1)-(N), respectively. Additionally or alternatively, rectifiers 404(1)-(N) may be electrically and/or communicatively coupled to electrical components 110(1)-(N), respectively.

In some examples, wireless power receivers 106(1)-(N) may receive and/or obtain a wireless power transfer from wireless power transmitter 120. In one example, the wireless power transfer may stimulate and/or induce ACs 410(1)-(N) that are passed and/or delivered from antennas 402(1)-(N) to rectifiers 404(1)-(N), respectively. In this example, rectifiers 404(1)-(N) may convert and/or transform ACs 410(1)-(N) into DCs 412(1)-(N), respectively. Rectifiers 404(1)-(N) may pass and/or deliver DCs 412(1)-(N) to electrical components 110(1)-(N), respectively. In certain implementations, electrical components 110(1)-(N) may then use, consume, and/or be powered by DCs 412(1)-(N).

In some examples, antennas 402(1)-(N) may each include and/or represent any type or form of material and/or substance capable of radiating and/or receiving RF energy. Examples of materials used to form antennas 402(1)-(N) include, without limitation, coppers, aluminums, steels, stainless steels, silvers, golds, combinations or variations of one or more of the same, and/or any other suitable materials. In one example, antennas 402(1)-(N) may include and/or represent metal meshes consisting of a network of wires and/or threads. In this example, such metal meshes may each include and/or represent lattices and/or webbings of similar, identical, varied, gradient, and/or random sizes. For example, metal mesh antennas may each include and/or form various honeycomb-shaped lattices and/or structures that are completely or nearly invisible to the naked eye.

In some examples, antennas 402(1)-(N), rectifiers 404(1)-(N), and/or electrical components 110(1)-(N) may be of any suitable size and/or dimensions. In one example antennas 402(1)-(N), rectifiers 404(1)-(N), and/or electrical components 110(1)-(N) may be dimensioned to span and/or cover some or all of the visible area, plane, and/or region of one or more see-through lenses installed in an AR device. Additionally or alternatively, antennas 402(1)-(N), rectifiers 404(1)-(N), and/or electrical components 110(1)-(N) may span and/or cover certain areas, planes, and/or regions outside the optical path of the AR device and/or the view of its user. For example, antennas 402(1)-(N), rectifiers 404(1)-(N), and/or electrical components 110(1)-(N) may be arranged and/or be positioned outside the view of a user wearing the AR device.

In some examples, optical elements 104(1)-(N) and/or eyewear frame 102 may each include and/or represent an inactive area that is outside the view of the user wearing the AR device. In one example, such inactive areas may be concealed, obscured, and/or hidden from the view of the user. For example, an inactive area of optical elements 104(1)-(N) may constitute and/or represent a perimeter that is non-transparent, opaque, and/or invisible to the user. In this example, the inactive area of optical elements 104(1)-(N) may be concealed, obscured, and/or hidden behind eyewear frame 102.

In some examples, conductive assemblies and/or electrical connections may be disposed, applied, and/or coupled to the inactive areas of optical elements 104(1)-(N). In one example, such conductive assemblies and/or electrical connections may provide electrical power and/or current to electrical components 110(1)-(N) and/or other devices or features of apparatus 400. Additionally or alternatively, a flexible electrical jumper may be disposed, applied, and/or coupled to such conductive assemblies and/or electrical connections in or along the inactive areas of optical elements 104(1)-(N). In certain implementations, the flexible electrical jumper may include and/or represent reduction traces that carry power and/or current to and/or from electrical components 110(1)-(N) and/or other devices or features of apparatus 400.

As a specific example, an anisotropic conductive film (ACF) may be disposed, applied, and/or coupled to a portion of the inactive area of optical element 104(1). In this example, the ACF may provide electrical power and/or current to electrical components 110(1)-(N) and/or other devices or features of apparatus 400. Additionally or alternatively, a flexible electrical jumper may be disposed, applied, and/or coupled atop the ACF in or along the inactive areas of optical elements 104(1)-(N). In one example, the flexible electrical jumper may facilitate, support, and/or provide one or more electrical paths that bypass the ACF in or along the inactive areas of optical elements 104(1)-(N). In this example, the electrical paths may constitute and/or form part of one or more circuits that avoid sharing electrical continuity with the ACF.

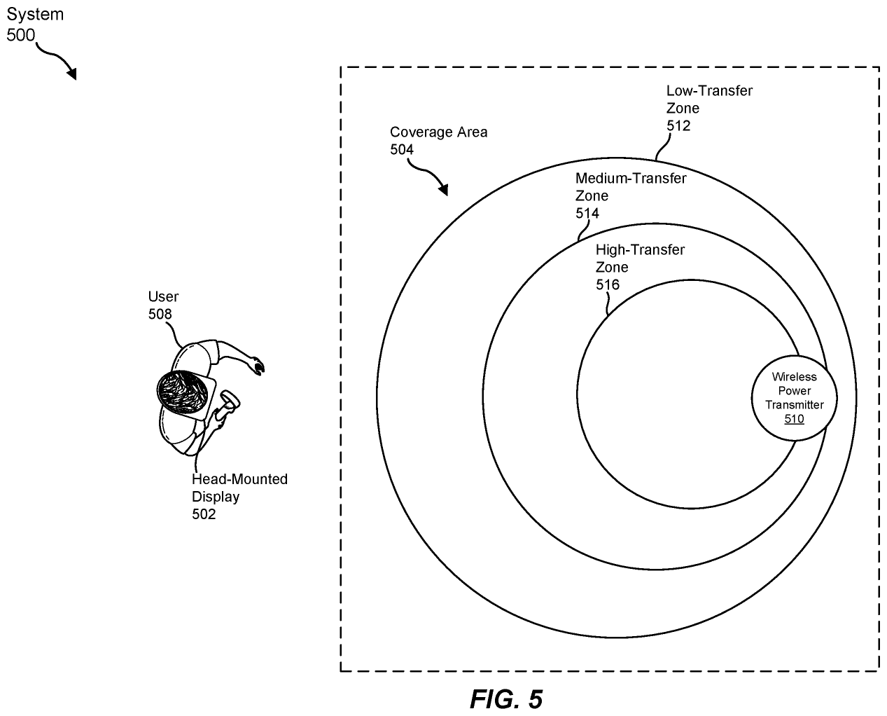

FIG. 5 illustrates an exemplary system 500 that includes and/or represents HMD 502 and a wireless power transmitter 510. In some examples, system 500 may include and/or involve certain devices, configurations, and/or features that perform and/or provide functionalities that are similar and/or identical to those described above in connection with any of FIGS. 1-4. As illustrated in FIG. 5, exemplary system 500 may include and/or involve a user 508 wearing and/or operating HMD 502 in a certain environment. In one example, the environment may include and/or represent all or a portion of a room in which wireless power transmitter 510 resides and/or is located. In certain implementations, wireless power transmitter 510 may include and/or represent a near-field power transmitter and/or a far-field power transmitter.

In some examples, wireless power transmitter 510 may be installed and/or placed several feet away from user 508 and/or HMD 502 within the environment. In one example, HMD 502 may determine and/or identify a coverage area 504 of wireless power transmitter 510 relative to the current position of HMD 502. HMD 502 may do so based at least in part on simultaneous localization and mapping (SLAM) data captured and/or recorded via onboard cameras, fiducial markers, charging-strength information, and/or power-transfer data. In certain implementations, HMD 502 may present and/or display an indicator in connection with coverage area 504 to user 508.

In some examples, the indicator may include and/or represent a visual representation of coverage area 504. As a specific example, the visual representation may include and/or represent a map illustrating coverage area 504 as a plurality of transfer and/or charging zones. For example, the map may illustrate and/or identify coverage area 504 as consisting of a high-transfer zone 516, a medium-transfer zone 514, and/or a low-transfer zone 512. In this example, high-transfer zone 516 may include and/or represent the area in which wireless power transmitter 510 is able to transfer the most power to HMD 502, and low-transfer zone 512 may include and/or represent the area in which wireless power transmitter 510 is able to transfer the least power to HMD 502. Accordingly, medium-transfer zone 514 may include and/or represent an area in which wireless power transmitter 510 is able to transfer more power to HMD 502 than in low-transfer zone 512 but less power to HMD 502 than in high-transfer zone 516.

In one example, the map may differentiate and/or distinguish high-transfer zone 516, medium-transfer zone 514, and/or low-transfer zone 512 in a variety of ways. For example, the different zones of coverage area 504 may be presented and/or displayed in different colors and/or with different labels to indicate their respective spans, ranges, and/or charging potentials. In certain implementations, high-transfer zone 516 may constitute and/or represent an effective power-transfer position for HMD 502. Accordingly, HMD 502 may direct and/or instruct user 508 to place HMD 502 in high-transfer zone 516 to achieve, engage, and/or take advantage of the optimal power-transfer potential of wireless power transmitter 510.

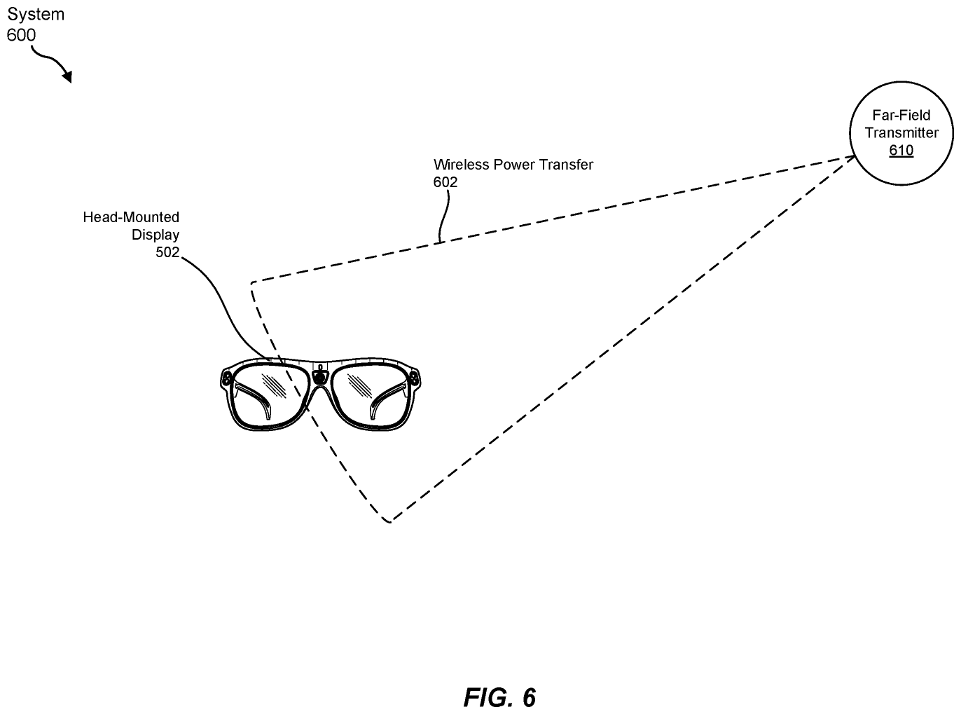

FIG. 6 illustrates an exemplary system 600 that includes and/or represents HMD 502 and a far-field transmitter 610. In some examples, system 600 may include and/or involve certain devices, configurations, and/or features that perform and/or provide functionalities that are similar and/or identical to those described above in connection with any of FIGS. 1-5. As illustrated in FIG. 6, exemplary system 600 may include and/or involve a user wearing and/or operating HMD 502 in a certain environment. In one example, the environment may include and/or represent all or a portion of a room in which far-field transmitter 610 resides and/or is located. In certain implementations, far-field transmitter 610 may perform, initiate, and/or provide a wireless power transfer 602 to HMD 502.

In some examples, the various devices and systems described in connection with FIGS. 1-6 may include and/or represent one or more additional circuits, components, and/or features that are not necessarily illustrated and/or labeled in FIGS. 1-6. For example, apparatus 100, 200, or 400 and/or system 500 or 600 may also include and/or represent additional analog and/or digital circuitry, onboard logic, transistors, radio-frequency (RF) transmitters, RF receivers, transceivers, antennas, resistors, capacitors, diodes, inductors, switches, registers, flipflops, connections, traces, buses, semiconductor (e.g., silicon) devices and/or structures, processing devices, storage devices, circuit boards, sensors, packages, substrates, housings, combinations or variations of one or more of the same, and/or any other suitable components. In certain implementations, one or more of these additional circuits, components, and/or features may be inserted and/or applied between any of the existing circuits, components, and/or features illustrated in FIGS. 1-6 consistent with the aims and/or objectives described herein. Accordingly, the electrical and/or communicative couplings described with reference to FIGS. 1-6 may be direct connections with no intermediate components, devices, and/or nodes or indirect connections with one or more intermediate components, devices, and/or nodes.

In some examples, the phrase “to couple” and/or the term “coupling,” as used herein, may refer to a direct connection and/or an indirect connection. For example, a direct coupling between two components may constitute and/or represent a coupling in which those two components are directly connected to each other by a single node that provides electrical continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide electrical continuity from one of those two components to the other. In other words, the indirect coupling may include and/or incorporate at least one additional component between those two components.

FIG. 7 is a flow diagram of an exemplary method 700 for configuring, assembling, and/or manufacturing an eyewear device capable of wirelessly powering electrical components on optical elements. In one example, the steps shown in FIG. 7 may be achieved and/or accomplished by a computing equipment manufacturer or subcontractor that manufactures and/or produces HMDs for AR experiences. Additionally or alternatively, the steps shown in FIG. 7 may incorporate and/or involve certain sub-steps and/or variations consistent with the descriptions provided above in connection with FIGS. 1-6.

As illustrated in FIG. 7, method 700 may include the step of installing at least one optical element into an eyewear frame (710). Step 710 may be performed in a variety of ways, including any of those described above in connection with FIGS. 1-6. For example, an AR equipment manufacturer or subcontractor may install and/or insert at least one optical element into an eyewear frame.

Method 700 may also include the step of disposing at least one wireless power receiver on the at least one optical element (720). Step 720 may be performed in a variety of ways, including any of those described above in connection with FIGS. 1-6. For example, the AR equipment manufacturer or subcontractor may dispose, apply, and/or secure at least one wireless power receiver on the at least one optical element.

Method 700 may further include the step of disposing at least one electrical component on the at least one optical element (730). Step 730 may be performed in a variety of ways, including any of those described above in connection with FIGS. 1-6. For example, the AR equipment manufacturer or subcontractor may dispose, apply, and/or secure at least one electrical component on the at least one optical element.

Method 700 may further include the step of electrically coupling the electrical component to the wireless power receiver to facilitate powering the electrical component by power received via a wireless power transfer between the wireless power receiver and a wireless power transmitter (740). Step 740 may be performed in a variety of ways, including any of those described above in connection with FIGS. 1-6. For example, the AR equipment manufacturer or subcontractor may electrically couple the electrical component to the wireless power receiver to facilitate powering the electrical component by power received via a wireless power transfer between the wireless power receiver and a wireless power transmitter.

### Example Embodiments

Example 1: An apparatus comprising (1) an eyewear frame that supports at least one optical element, (2) at least one wireless power receiver disposed on the at least one optical element and configured to receive a wireless power transfer from a wireless power transmitter, and (3) at least one electrical component disposed on the at least one optical element and electrically coupled to the wireless power receiver, wherein the electrical component is powered by the wireless power transfer.

Example 2: The apparatus of Example 1, wherein the wireless power receiver comprises at least one of a far-field power receiver or a near-field power receiver.

Example 3: The apparatus of either Example 1 or Example 2, wherein the at least one electrical component comprises one or more LEDs configured to emit light toward at least one eye of a user wearing the eyewear frame.

Example 4: The apparatus of any of Examples 1-3, further comprising (1) at least one camera secured to the eyewear frame, wherein the at least one camera is configured to detect at least a portion of the light that is reflected by the at least one eye of the user and (2) circuitry communicatively coupled to the at least one camera, wherein the circuitry is configured to track movement of the at least one eye based at least in part on the at least a portion of the light detected by the at least one camera.

Example 5: The apparatus of any of Examples 1-4, wherein the circuitry is further configured to modify virtual content presented via the optical element based at least in part on the movement of the at least one eye.

Example 6: The apparatus of any of Examples 1-5, wherein the one or more LEDs comprises one or more microLEDs positioned around a periphery of the optical element.

Example 7: The apparatus of any of Examples 1-6, wherein the at least one wireless power receiver comprises at least one antenna configured to be substantially invisible to a user wearing the eyewear frame.

Example 8: The apparatus of any of Examples 1-7, further comprising a rectifier electrically coupled between the wireless power receiver and the electrical component, wherein the rectifier is configured to convert alternating current received via the wireless power transfer to direct current and provide the direct current to the electrical component.

Example 9: The apparatus of any of Examples 1-8, wherein (1) the at least one wireless power receiver comprises a plurality of wireless power receivers positioned along a periphery of the optical element and (2) the at least one electrical component comprises a plurality of electrical components that are each electrically coupled to one of the plurality of wireless power receivers positioned along the periphery of the optical element.

Example 10: The apparatus of any of Examples 1-9, further comprising a wireless communication transmitter, and wherein the at least one optical element comprises a lens configured to operate as a resonator antenna of the wireless communication transmitter.

Example 11: A system comprising (1) a wireless power transmitter and (2) a head-mounted display comprising (A) an eyewear frame that supports at least one optical element, (B) at least one wireless power receiver disposed on the at least one optical element and configured to receive a wireless power transfer from the wireless power transmitter, and (C) at least one electrical component disposed on the at least one optical element and electrically coupled to the wireless power receiver, wherein the electrical component is powered by the wireless power transfer.

Example 12: The system of Example 11, wherein the wireless power receiver comprises at least one of a far-field power receiver or a near-field power receiver.

Example 13: The system of Example 11 or Example 12, wherein the at least one electrical component comprises one or more LEDs configured to emit light toward at least one eye of a user wearing the eyewear frame.

Example 14: system of any of Examples 11-13, further comprising (1) at least one camera secured to the eyewear frame, wherein the at least one camera is configured to detect at least a portion of the light that is reflected by the at least one eye of the user and (2) circuitry communicatively coupled to the at least one camera, wherein the circuitry is configured to track movement of the at least one eye based at least in part on the at least a portion of the light detected by the at least one camera.

Example 15: The system of any of Examples 11-14, wherein the circuitry is further configured to modify virtual content presented via the optical element based at least in part on the movement of the at least one eye.

Example 16: The system of any of Examples 11-15, wherein the one or more fasteners comprise a spring clip that supports both the high-band antenna and the low-band antenna simultaneously.

Example 17: The system of any of Examples 11-16, wherein the at least one wireless power receiver comprises at least one antenna configured to be substantially invisible to a user wearing the eyewear frame.

Example 18: The system of any of Examples 11-17, further comprising a rectifier electrically coupled between the wireless power receiver and the electrical component, wherein the rectifier is configured to convert alternating current received via the wireless power transfer to direct current and provide the direct current to the electrical component.

Example 19: The system of any of Examples 11-18, wherein (1) the at least one wireless power receiver comprises a plurality of wireless power receivers positioned along a periphery of the optical element and (2) the at least one electrical component comprises a plurality of electrical components that are each electrically coupled to one of the plurality of wireless power receivers positioned along the periphery of the optical element.

Example 20: A method comprising (1) installing at least one optical element into an eyewear frame, (2) disposing at least one wireless power receiver on the at least one optical element, (3) disposing at least one electrical component on the at least one optical element, and (4) electrically coupling the electrical component to the wireless power receiver to facilitate powering the electrical component by power received via a wireless power transfer between the wireless power receiver and a wireless power transmitter.

Embodiments of the present disclosure may include or be implemented in conjunction with various types of artificial-reality systems. Artificial reality is a form of reality that has been adjusted in some manner before presentation to a user, which may include, for example, a VR, an AR, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a 3D effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., AR system 800 in FIG. 8) or that visually immerses a user in an artificial reality (such as, e.g., VR system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, AR system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While AR system 800 includes two displays, embodiments of this disclosure may be implemented in AR systems with a single NED or more than two NEDs.

In some embodiments, AR system 800 may include one or more sensors, such as sensor 840. Sensor 840 may generate measurement signals in response to motion of AR system 800 and may be located on substantially any portion of frame 810. Sensor 840 may represent one or more of a variety of different sensing mechanisms, such as a position sensor, an inertial measurement unit (IMU), a depth camera assembly, a structured light emitter and/or detector, or any combination thereof. In some embodiments, AR system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

In some examples, AR system 800 may also include a microphone array with a plurality of acoustic transducers 820(A)-820(J), referred to collectively as acoustic transducers 820. Acoustic transducers 820 may represent transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(I) and 820(J), which may be positioned on a corresponding neckband 805.

In some embodiments, one or more of acoustic transducers 820(A)-(J) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While AR system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), AR system 800 may simulate binaural hearing and capture a 3D stereo sound field around about a user's head. In some embodiments, acoustic transducers 820(A) and 820(B) may be connected to AR system 800 via a wired connection 830, and in other embodiments acoustic transducers 820(A) and 820(B) may be connected to AR system 800 via a wireless connection (e.g., a BLUETOOTH connection). In still other embodiments, acoustic transducers 820(A) and 820(B) may not be used at all in conjunction with AR system 800.

Acoustic transducers 820 on frame 810 may be positioned in a variety of different ways, including along the length of the temples, across the bridge, above or below display devices 815(A) and 815(B), or some combination thereof. Acoustic transducers 820 may also be oriented such that the microphone array is able to detect sounds in a wide range of directions surrounding the user wearing the AR system 800. In some embodiments, an optimization process may be performed during manufacturing of AR system 800 to determine relative positioning of each acoustic transducer 820 in the microphone array.

In some examples, AR system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with AR eyewear devices may enable the eyewear devices to achieve the form factor of a pair of glasses while still providing sufficient battery and computation power for expanded capabilities. Some or all of the battery power, computational resources, and/or additional features of AR system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 805 may be communicatively coupled with eyewear device 802 and/or to other devices. These other devices may provide certain functions (e.g., tracking, localizing, depth mapping, processing, storage, etc.) to AR system 800. In the embodiment of FIG. 8, neckband 805 may include two acoustic transducers (e.g., 820(I) and 820(J)) that are part of the microphone array (or potentially form their own microphone subarray). Neckband 805 may also include a controller 825 and a power source 835.

Acoustic transducers 820(I) and 820(J) of neckband 805 may be configured to detect sound and convert the detected sound into an electronic format (analog or digital). In the embodiment of FIG. 8, acoustic transducers 820(I) and 820(J) may be positioned on neckband 805, thereby increasing the distance between the neckband acoustic transducers 820(I) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or AR system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which AR system 800 includes an inertial measurement unit, controller 825 may compute all inertial and spatial calculations from the IMU located on eyewear device 802. A connector may convey information between AR system 800 and neckband 805 and between AR system 800 and controller 825. The information may be in the form of optical data, electrical data, wireless data, or any other transmittable data form. Moving the processing of information generated by AR system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium-ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial-reality systems may, instead of blending an artificial reality with actual reality, substantially replace one or more of a user's sensory perceptions of the real world with a virtual experience. One example of this type of system is a head-worn display system, such as VR system 900 in FIG. 9, that mostly or completely covers a user's field of view. VR system 900 may include a front rigid body 902 and a band 904 shaped to fit around a user's head. VR system 900 may also include output audio transducers 906(A) and 906(B). Furthermore, while not shown in FIG. 9, front rigid body 902 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in AR system 800 and/or VR system 900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in AR system 800 and/or VR system 900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, AR system 800 and/or VR system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An apparatus comprising:
an eyewear frame that supports at least one optical element;
at least one wireless power receiver disposed on the at least one optical element and configured to receive a wireless power transfer from a wireless power transmitter; and
at least one electrical component disposed on the at least one optical element and electrically coupled to the at least one wireless power receiver, wherein the at least one electrical component is powered by the wireless power transfer.

2. The apparatus of claim 1, wherein the at least one wireless power receiver comprises at least one of:
a far-field power receiver; or
a near-field power receiver.

3. The apparatus of claim 1, wherein the at least one electrical component comprises one or more light-emitting diodes (LEDs) configured to emit light toward at least one eye of a user wearing the eyewear frame.

4. The apparatus of claim 3, further comprising:
at least one camera secured to the eyewear frame, wherein the at least one camera is configured to detect at least a portion of the light that is reflected by the at least one eye of the user; and
circuitry communicatively coupled to the at least one camera, wherein the circuitry is configured to track movement of the at least one eye based at least in part on the at least a portion of the light detected by the at least one camera.

5. The apparatus of claim 4, wherein the circuitry is further configured to modify virtual content presented via the at least one optical element based at least in part on the movement of the at least one eye.

6. The apparatus of claim 3, wherein the one or more LEDs comprises one or more microLEDs positioned around a periphery of the at least one optical element.

7. The apparatus of claim 1, wherein the at least one wireless power receiver comprises at least one antenna configured to be substantially invisible to a user wearing the eyewear frame.

8. The apparatus of claim 1, further comprising a rectifier electrically coupled between the at least one wireless power receiver and the at least one electrical component, wherein the rectifier is configured to:
convert alternating current received via the wireless power transfer to direct current; and
provide the direct current to the at least one electrical component.

9. The apparatus of claim 1, wherein:
the at least one wireless power receiver comprises a plurality of wireless power receivers positioned along a periphery of the at least one optical element; and
the at least one electrical component comprises a plurality of electrical components that are each electrically coupled to one of the plurality of wireless power receivers positioned along the periphery of the at least one optical element.

10. The apparatus of claim 1, further comprising a wireless communication transmitter; and
wherein the at least one optical element comprises a lens configured to operate as a resonator antenna of the wireless communication transmitter.

11. The apparatus of claim 1, wherein the wireless power transmitter is coupled to the eyewear frame.

12. The apparatus of claim 1, wherein:
the at least one optical element forms a hole; and
the at least one electrical component is embedded in the hole; and further comprising:
molding that secures the at least one electrical component in the hole; and
at least one electrical connection that electrically couples the at least one electrical component to a trace disposed on the at least one optical element.

13. The apparatus of claim 1, wherein
the at least one optical element forms a hole; and
the at least one electrical component is disposed on the optical element proximate to the hole; and
further comprising:
a first trace that is disposed on a first side of the optical element and is electrically coupled to the at least one electrical component;
a second trace disposed on a second side of the optical element; and
at least one electrical connection that electrically couples the first trace and the second trace to one another via the hole.

14. The apparatus of claim 1, wherein the optical element comprises an inactive area configured to be positioned outside a view of a user wearing the eyewear frame; and
further comprising:
one or more traces disposed on the optical element in the inactive area; and
at least one flexible electrical jumper applied over the one or more traces such that flexible electrical jumper avoids sharing electrical continuity with the one or more traces.

15. A system comprising:
a wireless power transmitter; and
a head-mounted display comprising:
an eyewear frame that supports at least one optical element;
at least one wireless power receiver disposed on the at least one optical element and configured to receive a wireless power transfer from the wireless power transmitter; and
at least one electrical component disposed on the at least one optical element and electrically coupled to the at least one wireless power receiver, wherein the at least one electrical component is powered by the wireless power transfer.

16. The system of claim 12, wherein the at least one wireless power receiver comprises at least one of:
a far-field power receiver; or
a near-field power receiver.

17. The system of claim 12, wherein the at least one electrical component comprises one or more light-emitting diodes (LEDs) configured to emit light toward at least one eye of a user wearing the eyewear frame.

18. The system of claim 14, further comprising:
at least one camera secured to the eyewear frame, wherein the at least one camera is configured to detect at least a portion of the light that is reflected by the at least one eye of the user; and
circuitry communicatively coupled to the at least one camera, wherein the circuitry is configured to track movement of the at least one eye based at least in part on the at least a portion of the light detected by the at least one camera.

19. The system of claim 15, wherein the circuitry is further configured to modify virtual content presented via the at least one optical element based at least in part on the movement of the at least one eye.

20. A method comprising:
installing at least one optical element into an eyewear frame;
disposing at least one wireless power receiver on the at least one optical element;
disposing at least one electrical component on the at least one optical element; and
electrically coupling the at least one electrical component to the at least one wireless power receiver to facilitate powering the at least one electrical component by power received via a wireless power transfer between the at least one wireless power receiver and a wireless power transmitter.
